(19) United States
(12) Patent Application Publication
(10) Pub. No.: US 2004/0055190 A1
(43) Pub. Date: Mar. 25, 2004

(54) Crystal ball structure delivering multi-layer rotation and light effects

(76) Inventor: Jack Liu, Hsin-Chu (TW)

Correspondence Address: David E. Dougherty, 612 Crystal Square 4, 1745 Jefferson Davis Highway, Arlington, VA, 22202-3417, US

(21) Appl. No.: 10/252,713

(22) Filed: Sep. 24, 2002

(51) Int. Cl. G09F 19/00

(52) U.S. Cl. 40/406

(57) ABSTRACT

This invention is related to a crystal ball structure delivering multi-layer rotation and light effects, comprising a crystal ball, a seat, ornaments, a rubber plug, model containers, a rotation mechanism, a driving mechanism, a light, and a music box, wherein the rotation mechanism comprises a fixed plate, first rotation plate, second rotation plate, a follower, and at least an idle gear between said first rotation plate and said second plate. The mechanic energy released from the fastened spiral power spring drives the driving mechanism, the follower, the first rotation plate, the idle gear, and the second rotation plate to rotate. The light fixed on the first rotation plate or the fixed plate can rotate or stay still when it illuminates, setting off the dynamic effect of the ornaments.

### FIELD OF INVENTION

This invention is related to a crystal ball structure delivering multi-layer rotation and light effects, comprising a crystal ball, a seat, ornaments, a rubber plug, model containers, a rotation mechanism, a driving mechanism, a light, and a music box, wherein the rotation mechanism comprises a fixed plate, first rotation plate, second rotation plate, a follower, and at least an idle gear between said first rotation plate and said second plate. The mechanic energy released from the fastened spiral power spring drives the driving mechanism, the follower, the first rotation plate, the idle gear, and the second rotation plate to rotate. The light fixed on the first rotation plate or the fixed plate can rotate or stay still when it illuminates, setting off the dynamic decorative effect of the ornaments.

### BACKGROUND OF INVENTION

A “dynamic scenic ornament” refers to a crystal ball enclosing decorative models of trees, houses, castles, cartoons, or their combinations with a decorative background (e.g., virtual snowfall). The convex glass effect resulted from the crystal ball filled with liquid highlights the scenic ornament in the crystal ball. Moreover, if a music box with a manual spiral power spring is mounted in the seat of the crystal ball, both visual and audio effects will occur.

In order to enhance the dynamic effect of scenic ornaments, most of them can move regularly, such as a kind granny weaving a sweater on a swaying rocking chair, a rotating Santa Claus on a sledge driving deer, even a crystal ball filled with paillettes falling down slowly in the liquid, generating a scene of virtual snowfall. All of above dynamic ornaments are aimed to enhance the visual effect of crystal balls.

However, conventional dynamic scenic ornaments can only rotate in clockwise or counter clockwise, limiting the layouts of them and degrading the dynamic effect. If multi-layer rotation can be implemented, the dynamic scenic ornaments will be more vivid. For example, in a virtual scene, if an ornament rotates clockwise and another ornament rotates clockwise or counter clockwise, at a same speed or at a different speed, the entire scene will be more attractive in visual effect for the multi-layer rotation.

Further, besides the vivid 3D visual effect of multi-layer rotation, if decorative light is added in above visual scene, it will set off significantly the visual effect of the scene under the help of the convex glass effect of the crystal ball and the reflective effect of the liquid in the crystal ball. On the basis of years of experience in design of dynamic scenic ornaments, the inventor invents a crystal ball structure delivering multi-layer rotation and light effects.

### SUMMARY OF INVENTION

The main purpose of this invention is to provide a crystal ball structure delivering multi-layer rotation effect, comprising a crystal ball, a seat, ornaments, a rubber plug, model containers, a rotation mechanism, a driving mechanism, a light, and a music box, wherein the rotation mechanism comprises a fixed plate, first rotation plate, second rotation plate, a follower, and at least an idle gear between said first rotation plate and said second plate. The mechanic energy released from the fastened spiral power spring drives the driving mechanism, the follower, the first rotation plate, the idle gear, and the second rotation plate to rotate simultaneously. The first rotation plate and the second rotation plate can rotate in the same direction or in contrary directions at the same speed or at different speeds, depending on the number of idle gears between them. Thus the dynamic effect of the ornaments on the first rotation plate and the second rotation plate will be much richer.

Another purpose of this invention is to provide a crystal ball structure with light effect, i.e., a light is mounted on said first rotation plate or said fixed plate, and the light can rotate or stay still on the fixed plate when it illuminates, setting off the dynamic decorative effect of said scene.

The foregoing and other technical contents of the invention can be further realized with the drawings and detailed explanations of the embodiments.

### BRIEF DESCRIPTION OF DRAWINGS

FIG. 1 is a 3D exploded view according to the first embodiment of this invention.

FIG. 2 is a sectional view according to the first embodiment of this invention.

FIG. 3 is an assembly drawing of the invention.

FIG. 4 is a 3D exploded view according to the second embodiment of this invention.

FIG. 5 is a sectional view according to the second embodiment of this invention.

FIG. 6 is a 3D exploded view according to the third embodiment of this invention.

FIG. 7 is a sectional view according to the third embodiment of this invention.

### DETAILED DESCRIPTIONS OF EMBODIMENTS

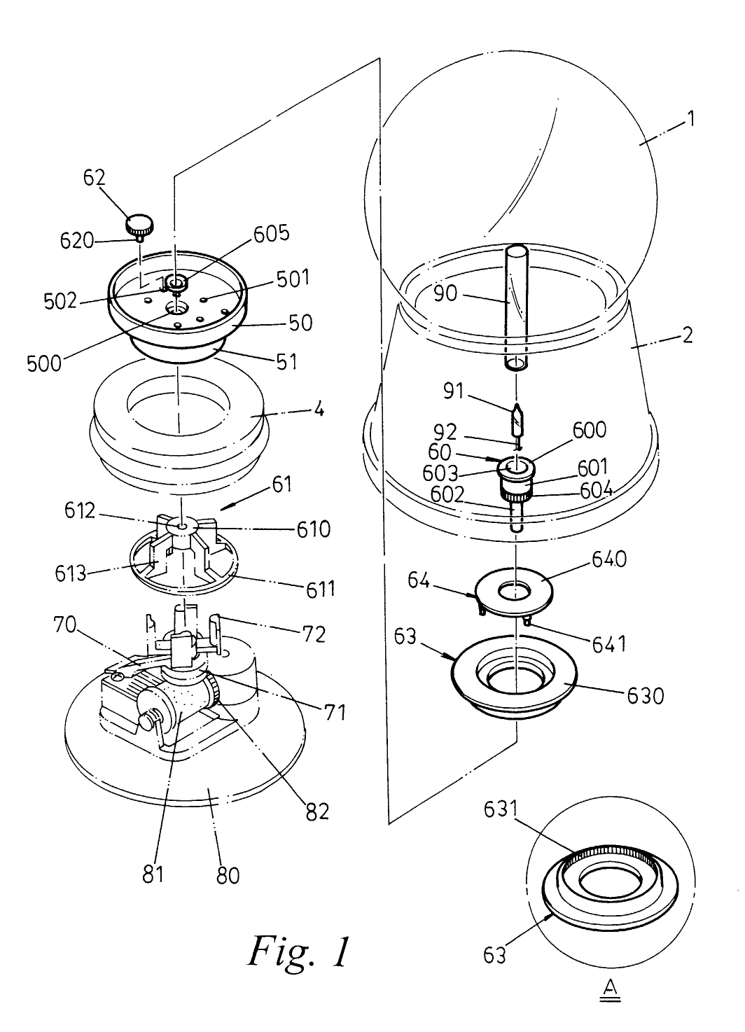

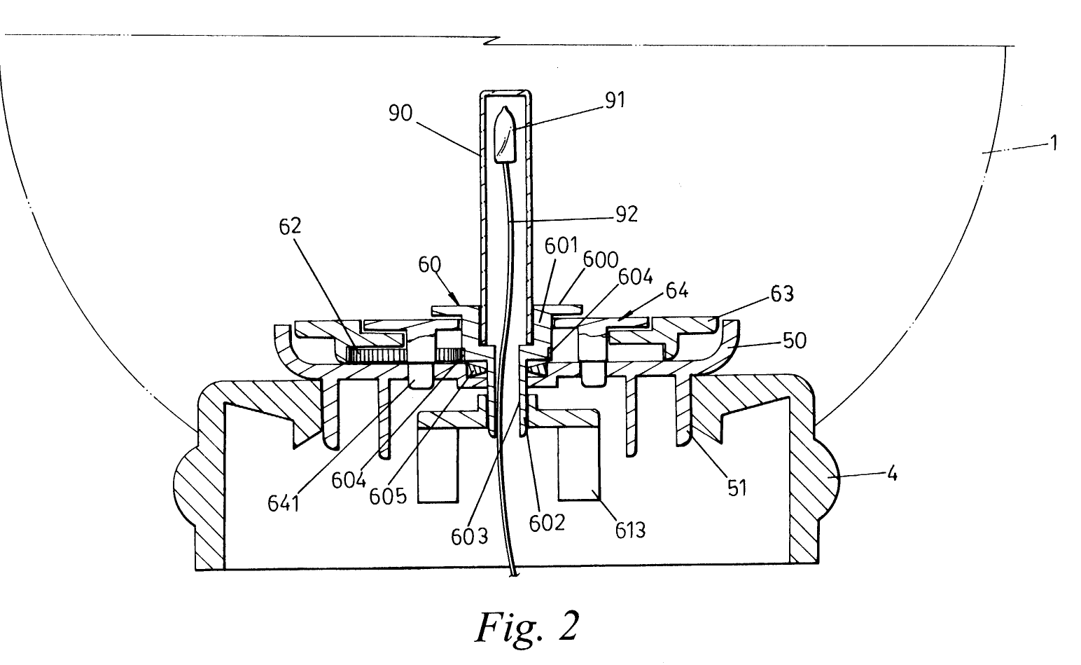

Please refer to FIG. 1 and FIG. 2 that are a 3D exploded view and a sectional view of the crystal ball according to the first embodiment of this invention. Said embodiment comprises a crystal ball, a seat, ornaments, a rubber plug, model containers, a driving mechanism, a light, and a music box.

Wherein the music box also serves as the power source for the rotation of the ornaments. After the spiral power spring is fastened manually via the pivot under the seat and then released, it will drive the wheel 81 of the music box, and at the same time, drive the vertical driving gear 82.

The driving mechanism is mounted on a bracket 70 on top of the music box, and it is driven to rotate when the horizontal coronal gear 71 under the shaft and said driving gear 82 couple with each other. Thus the 4 driving arms 72 rotate along with the driving mechanism.

The follower 61 of the rotation mechanism comprises a central shaft 610 and a round ring 611, wherein the central shaft 610 has a hole 612 to couple with the connecting shaft 602 connected to the first rotation plate 60. There are 4 following arms 613 on the central shaft 610 at the position of the round plate 611, and they can be coupled with said driving arms 72 to rotate, thus the first rotation plate 60 rotates with the following arms 613.

The model container comprises a round containing plate 50 and a hollow cylinder 51, wherein the containing plate 50 has a central hole 500, a fixing hole 501 at the eccentric center, and a locating hole 502 at the eccentric center, and the hollow cylinder 51 is conglutinated with the rubber plug 4.

The first rotation plate 60 on the rotation mechanism comprises a plate 600 on the top, a driving shaft 601 in the middle, and a connecting shaft 602 at the bottom. Each of the three shafts has a trough hole 603 at the center. The plate 600 on the top is used to fix an ornament. The driving shaft 601 in the middle has a spur gear 604, which is used to drive a driving idle gear 62. The connecting shaft 602 at the bottom penetrates the through hole 500 on said containing plate 50 and is fixed in the central hole 612 of said follower 61.

The transparent tube 90 of said light is inserted in the through hole 603 of the plate 600 on the top of said first rotation plate 60. The transparent tube 90 contains a lamp bulb 91, the lead 92 of which runs through the through hole 603 of said first rotation plate 60 and extends downwards to the power supply unit (not shown).

The idle gear 62 of the rotation mechanism gears into the spur gear 604 on the driving shaft 601 in the middle of the first rotation plate 60. The shaft 620 of said idle gear 62 is inserted in the location hole 502 at the eccentric center.

Please refer to view A in the FIG. 2. The second rotation plate 63 on the rotation mechanism comprises a plate 630 containing an ornament and an internal tooth ring 631 coupled with said idle gear 62.

The fixed plate 64 on the rotation mechanism comprises a plate 640 containing an ornament and a fixing pin 641 extending downwards. The fixing pin 641 is fixed in the fixing hole 501 on the containing plate 50, and it fixes the second rotation plate 63 on the containing plate 50.

In assembling the first embodiment of the invention, firstly, install and fix said rotation mechanism and the light on the model container, and agglutinate the ornaments on the first rotation plate 60, the fixed plate 64, and the second rotation plate 63, and fuse or agglutinate the rubber plug 4 onto the hollow cylinder 51 of the model container with ultrasonic technology. After fitting the opening of the crystal ball 1 onto the seat 2 and agglutinate together and fill the crystal ball with liquid, press the rubber plug 4 firmly into the opening of the crystal ball 1 to avoid potential leakage of the liquid from the crystal ball 1. At last, fix the bottom plate (with a music box) onto the bottom of the seat.

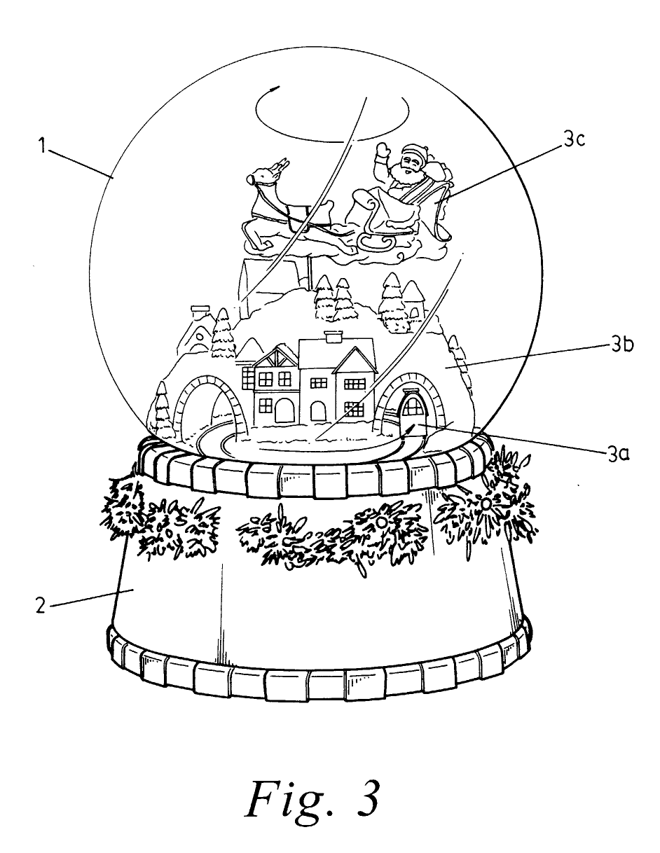

Please refer to FIG. 3. After this invention is assembled, when the spiral power spring is fastened and then released, the spiral power spring will drive the wheel 81 of the music box to play the music and at the same time drive said driving arms 72, following arms 613, the first rotation plate 60, the driving idle gear 62, and the second rotation plate 63 to rotate. Because that the second rotation plate 63 is driven by the first rotation plate 60 via the idle gear 62, the first rotation plate 60 and the second rotation plate 63 rotate in contrary directions. Thus the ornaments on them also rotate in contrary directions, setting off the dynamic result and make the scene more vivid. As shown in FIG. 3, the train model 3a is fixed on said second rotation plate 63, which rotates counter clockwise. The model 3b of tunnel and houses is fixed on said first rotation plate 60, which rotates clockwise. Under the drive of the rotation mechanism, the model 3b of tunnel and houses stays still; the model 3c of Santa Claus driving a sledge rotates clockwise; the train model 3a rotates counter clockwise. The combination of moving scenes and static scene makes the invention more vivid. Furthermore, the light (not shown) on the first rotation plate 60 rotates and illuminates as the models rotate, setting off the beauty of the invention.

In above first embodiment of this invention, if more idle gears are applied between the first rotation plate 60 and the second rotation plate 63, for example, another idle gear may be installed beside said idle gear 62, and it may be geared to the second rotation plate 63. Thus the first rotation plate 60 and the second rotation plate 63 will rotate in the same direction through the two idle gears. Furthermore, the size of the second idle gear may be different to that of the first idle gear 60 to change the rotation speed of the second rotation plate 63. In this way, multi rotation patterns can be implemented.

In above first embodiment of this invention, because that the light is mounted on the first rotation plate 60, it rotates along with the first plate 60. However, in some scenic designs, it is required that the light stays still to match the entire scene. Therefore, in the second embodiment of this invention, the light may be fixed on the fixed plate on the rotation mechanism to keep it stay still.

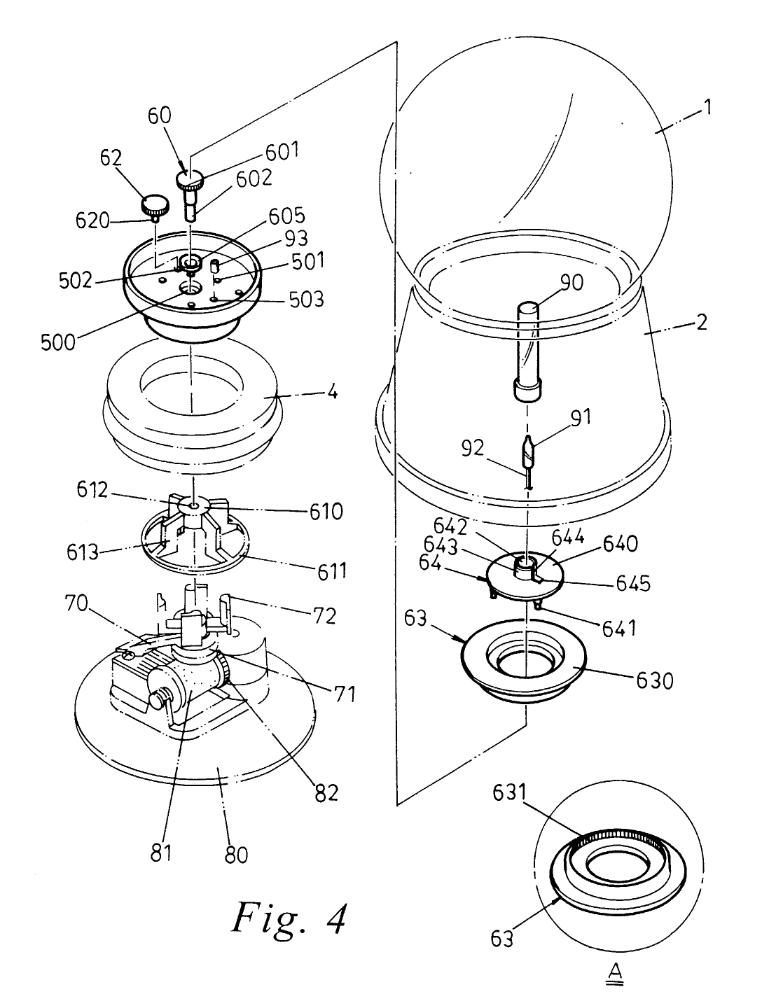

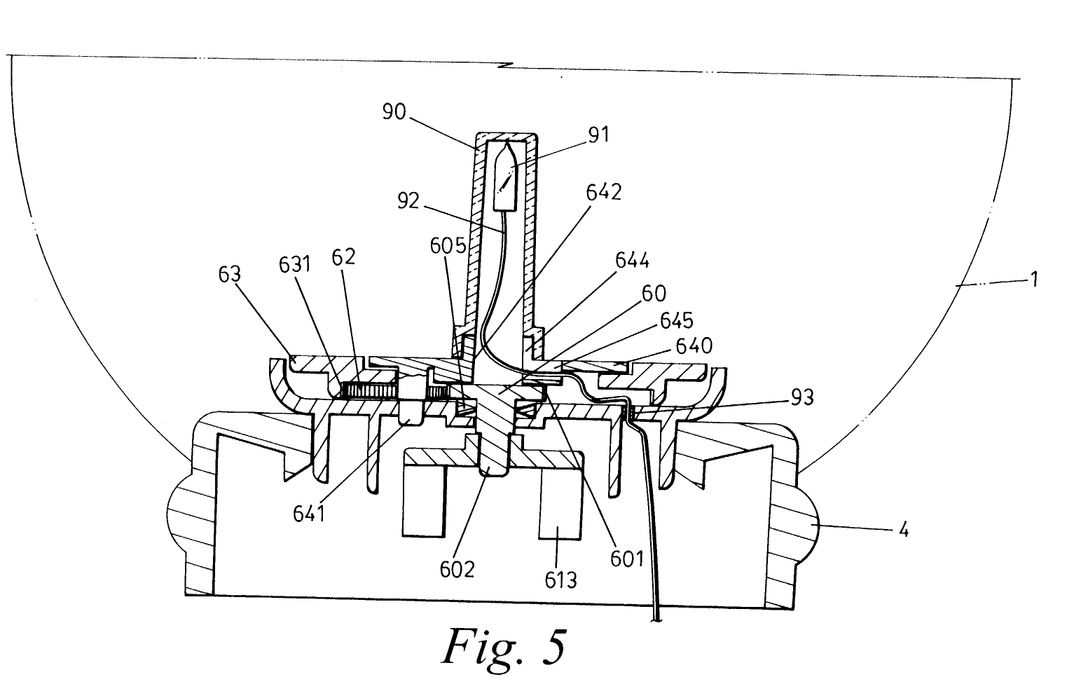

Please refer to FIG. 4 and FIG. 5 that are a 3D exploded view and a sectional view of crystal ball according to this invention, wherein:

The model container comprises a round containing plate 50 and a hollow cylinder 51. The containing plate 50 has a central though hole 500, a fixing hole 501 at the eccentric center, a location hole 502 at the eccentric center, and a power lead hole 503. The hollow cylinder 51 is agglutinate with the rubber plug 4.

The first rotation plate 60 comprises a top gear 601 to drive the idle gear and a connecting shaft 602 fitted with a shaft gland 605. The connecting shaft 602 runs through the through hole 500 of said containing plate 50 and is fixed in the central hole 612 of the follower 61.

The idle gear 62 on the rotation mechanism is geared to the top gear 601 on said first rotation plate 60. The shaft 620 of the idle gear 62 is inserted into the location hole 502 at the eccentric center of the containing plate 50.

Please refer to view A in the FIG. 4. The second rotation plate 63 on the rotation mechanism comprises a hollow plate 631 containing an ornament and an internal tooth ring 631 geared to said idle gear 62.

The fixed plate 64 on the rotation mechanism comprises a plate 640 containing an ornament and a fixing pin 641 extruding downwards. The fixing pin 641 is fixed in the fixing hole 501 of the containing plate 50, and it fixes the second rotation plate 63 on the containing plate 50. The fixed plate 64 has a shaft hole 642 at the center, which has an end tube 643 at the top. There is a notch 644 on the end tube 643 along the axis. There is also a horizontal long groove 645 on the fixed plate 640, against the notch 644 on the end tube 643;

The transparent tube 90 of the light is inserted in the end tube 643 at the center of said fixed plate 64. The transparent tube 90 contains a lamp 91, the lead 92 of which runs through the L-type gap formed by the notch 644 on said end tube 643 and the long groove 645 on the fixed plate 640 and the power lead hole 503 on the containing plate 50 and reaches to the power supply unit (not shown). In order to avoid any leakage of the liquid from the crystal ball, a rubber seal 93 should be applied at the power lead hole 503 on the containing plate 50, where the power lead 90 runs through.

In that way, the second embodiment of the invention provides another driving pattern, i.e., the light and scenic model fixed on the fixed plate 64 stay still. However, the scenic model fixed on the second rotation plate 63 rotates around the fixed scenic model on said rotation plate 64. At the same time, the light fixed on the fixed plate 64 keeps illuminating, highlighting the scene.

In above first embodiment and the second embodiment, if the light is mounted on the first rotation plate 60 on the rotation mechanism, the light will rotate along with the first rotation plate 60; however, if the light is mounted on the fixed plate 64, the light will stay still. But in some cases, due to the limitation on scene design or the cost, the light has to be omitted. In the third embodiment of this invention, which is described hereunder, a crystal ball structure with multi-layer rotation effect but no light component is disclosed.

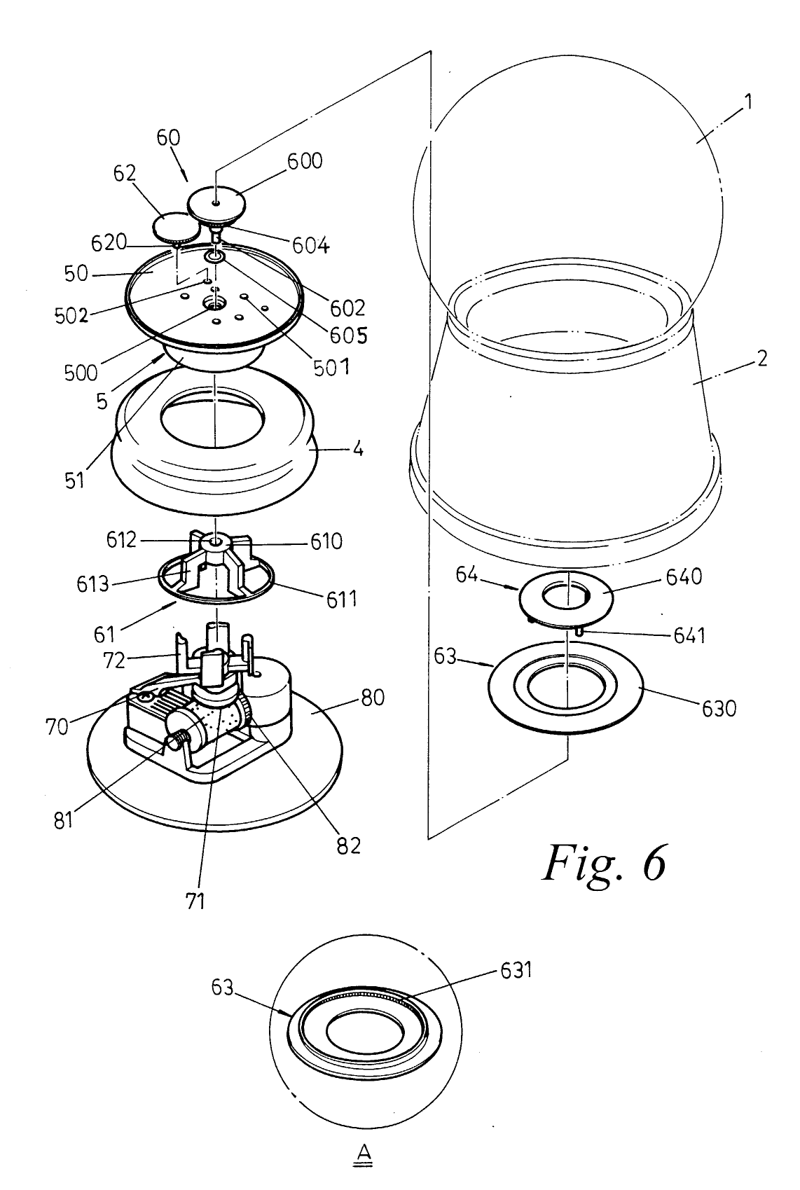

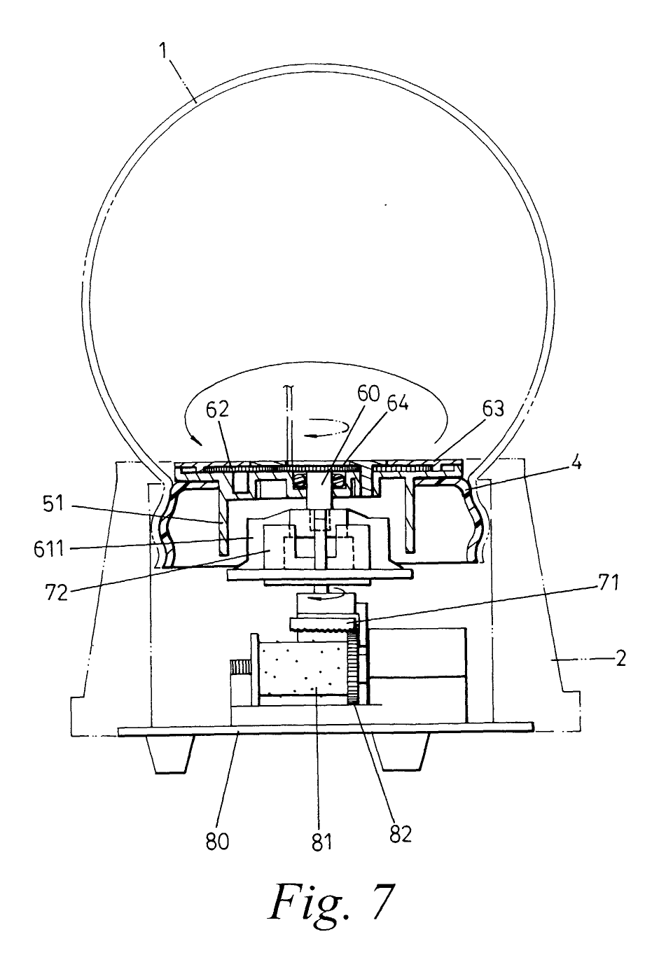

Please refer to FIG. 6 and FIG. 7 that are a 3D exploded view and a sectional view of crystal ball according to the third embodiment of this invention. Wherein:

The model container comprise a round containing plate 50 and a hollow cylinder 51, wherein the containing plate 50 has a through hole 500, a fixing hole 501 and a position hole 502. The hollow cylinder 51 is agglutinate with a rubber plug 4;

The first rotation plate 60 on the rotation mechanism comprises a plate 600 containing a thematic model, a spur gear 604 under the plate 600, and a connecting shaft 602 under the plate 600, wherein the connecting shaft 602 is fitted with a shaft gland 605. The connecting shaft 602 runs through the through hole 500 of said containing plate 50 and is geared to the follower 61.

The follower 61 on the rotation mechanism comprises a central shaft 610 and a round ring 611, wherein the central shaft 610 has a hole 612, through which the central shaft 610 is coupled firmly with the connecting shaft 602 of the first rotation plate 60. The central shaft 610 extends downwards and has 4 following arms 613 at the bottom, which are coupled with said driving arms 72 and rotate with the first rotation plate 60 under the drive of said driving arms 72;

The idle gear 62 on the rotation mechanism is geared to the top gear 601 on said first rotation plate 60. The shaft 620 of the idle gear 62 is inserted into the location hole 502 of the containing plate 50.

Please refer to view A in the FIG. 6. The second rotation plate 63 on the rotation plate comprises a hollow plate 630 containing a thematic model and an internal tooth ring 631 geared to said idle gear 62;

The fixed plate 64 on the rotation mechanism comprises a plate 640 containing a thematic model and a fixing pin 641 extending downwards. The fixing pin 641 is fixed in the fixing hole 501 on the containing plate 50, and it fixes the second rotation plate 63 on the containing plate 50.

In assembling the third embodiment of the invention, firstly, install and fix the components of said rotation mechanism on the model container, and agglutinate the thematic models on the first rotation plate 60, the fixed plate 64, and the second rotation plate 63, and fuse or agglutinate the rubber plug 4 onto the hollow cylinder 51 of the model container with ultrasonic technology. After fitting the opening of the crystal ball 1 onto the seat 2 and agglutinate together and fill the crystal ball with liquid, press the rubber plug 4 firmly into the opening of the crystal ball 1 to avoid potential leakage of the liquid from the crystal ball 1. At last, fix the bottom plate 80 (with a music box) onto the bottom of the seat.

After that embodiment is assembled, when the spiral power spring is fastened and then released, the spiral power spring will drive the wheel 81 of the music box to play the music and at the same time drive said driving arms 72, following arms 613, the first rotation plate 60, the driving idle gear 62, and the second rotation plate 63 to rotate. Because that the second rotation plate 63 is driven by the first rotation plate 60 via the idle gear 62, the first rotation plate 60 and the second rotation plate 63 rotate in contrary directions. Thus the thematic models on them also rotate in contrary directions, setting off the dynamic result and make the scene more vivid.

What is claimed is:

1. A crystal ball structure delivering multi-layer rotation and light effects, comprising a crystal ball, a seat, ornaments, a rubber plug, model containers, a rotation mechanism, a driving mechanism, a light, and a music box, the wheel of the music box drives the vertical driving gear on the same shaft to rotate; said driving mechanism rotates through the gearing between a horizontal coronal gear and said vertical driving gear to drive the driving arms on the top of the shaft to rotate; wherein:
the model container comprises a round containing plate and a hollow cylinder, the containing plate has a central through hole, a fixing hole at the eccentric center, and a location hole at the eccentric center; and the hollow cylinder is agglutinated with said rubber plug;
the first rotation plate on the rotation mechanism comprises a plate on the top, a driving shaft in the middle, and a coupling shaft at the bottom, and each of the three shafts has a trough hole at the center; said plate on the top is used to fix an ornament, the driving shaft in the middle has a spur gear, which is used to drive an idle gear, the coupling shaft at the bottom penetrates the through hole on said containing plate and is fixed in the central hole of said follower;
the transparent tube of said light is inserted in the through hole of said plate on the top of said first rotation plate, the transparent tube contains a lamp bulb, the lead of which runs through the through hole of said first rotation plate and extends to the power supply unit;
the idle gear of the rotation mechanism gears into the spur gear on said driving shaft in the middle of said first rotation plate, the shaft of said idle gear is inserted in the location hole on said containing plate;
the second rotation plate on the rotation mechanism comprises a plate containing an ornament and an internal tooth ring coupled with said idle gear;
the fixed plate on the rotation mechanism comprises a plate containing an ornament and a fixing pin extending downwards, the fixing pin is fixed in said fixing hole on said containing plate, and it fixes the second rotation plate on said containing plate;

2. The crystal ball structure delivering multi-layer rotation and light effects according to claim 1, wherein a second idle gear can be installed beside said idle gear, and it can be geared to said second rotation plate.

3. A crystal ball structure delivering multi-layer rotation and light effects, comprising a crystal ball, a seat, ornaments, a rubber plug, model containers, a rotation mechanism, a driving mechanism, a light, and a music box, the wheel of the music box drives the vertical driving gear on the same shaft to rotate; said driving mechanism rotates through the gearing between a horizontal coronal gear and said vertical driving gear to drive the driving arms on the top of the shaft to rotate; wherein:
the model container comprises a round containing plate and a hollow cylinder, the containing plate has a central through hole, a fixing hole, a location hole, and a lead hole; the hollow cylinder is agglutinated with said rubber plug;
the first rotation plate on the rotation mechanism comprises a plate on the top, a driving shaft in the middle, and a coupling shaft at the bottom, and each of the three shafts has a trough hole at the center;
said plate on the top is used to fix an ornament, the driving shaft in the middle has a spur gear, which is used to drive an idle gear, the coupling shaft at the bottom penetrates the through hole on said containing plate and is fixed on the connecting shaft in the central hole of said follower;
the idle gear of the rotation mechanism gears into the spur gear on said driving shaft in the middle of said first rotation plate, the shaft of said idle gear is inserted in the location hole on said containing plate;
The fixed plate on said rotation mechanism comprises a plate containing an ornament and a fixing pin extruding downwards, the fixing pin is fixed in the fixing hole of the containing plate, and it fixes said second rotation plate on the containing plate; said fixed plate has a hole at the center, which has an end tube at the top; there is a notch on the end tube along the axis; there is also a horizontal short groove on the fixed plate, against the notch on the end tube;
the transparent tube of the light is inserted in the end tube at the center of said fixed plate, and said transparent tube contains a lamp, the lead of which runs through the L-type gap formed by said notch on said end tube and the short groove on the fixed plate and the power lead hole on the containing plate and reaches to the power supply unit.

4. The crystal ball structure delivering multi-layer rotation and light effects according to claim 3, wherein there is a rubber seal to avoid liquid leakage from the crystal ball at said lead hole on said containing plate, where the power lead runs through.

5. A crystal ball structure delivering multi-layer rotation effect, comprising a crystal ball, a seat, ornaments, a rubber plug, model containers, a rotation mechanism, a driving mechanism, and a music box, the wheel of the music box drives the vertical driving gear on the same shaft to rotate; said driving mechanism rotates through the gearing between a horizontal coronal gear and said vertical driving gear to drive the driving arms on the top of the shaft to rotate; wherein:
the model container comprises a round containing plate and a hollow cylinder, the containing plate has a central through hole, a fixing hole, and a location hole; the hollow cylinder is agglutinated with said rubber plug;
the first rotation plate on the rotation mechanism comprises a plate at the top containing a thematic model, a driving shaft in the middle, and a coupling shaft at the bottom, and each of the three shafts has a trough hole at the center; said plate on the top is used to fix an ornament, the driving shaft in the middle has a spur gear, which is used to drive an idle gear, the coupling shaft at the bottom penetrates the through hole on said containing plate and is fixed on the connecting shaft in the central hole of said follower;
said first rotation plate on the rotation mechanism comprises a plate containing a thematic model, a spur gear under the plate, and a connecting shaft under the plate, said connecting shaft is fitted with a shaft gland, and it runs through the through hole of said containing plate and is geared to the follower;
the follower on the rotation mechanism comprises a central shaft and a round ring, the central shaft has a hole, through which said central shaft is coupled firmly with the connecting shaft of the first rotation plate, and it extends downwards and has 4 following arms at the bottom, which are coupled with said driving arms and rotate with the first rotation plate under the drive of said driving arms;
said idle gear on the rotation mechanism is geared to the top gear on said first rotation plate, the shaft of said idle gear is inserted into the location hole of the containing plate;
the second rotation plate on the rotation mechanism comprises a plate containing a thematic model and an internal tooth ring coupled with said idle gear;
the fixed plate on the rotation mechanism comprises a plate containing an thematic model and a fixing pin extending downwards; the fixing pin is fixed in said fixing hole on said containing plate, and it fixes the second rotation plate on said containing plate.

6. The crystal ball structure delivering multi-layer rotation effect according to claim 5, wherein a second idle gear can be installed beside said idle gear, and it can be geared to said second rotation plate.
